(19) United States
(12) Patent Application Publication
(10) Pub. No.: US 2026/0093153 A1
(43) Pub. Date: Apr. 2, 2026

(54) ELECTROPHORETIC ELEMENT, DISPLAY PANEL, AND DISPLAY DEVICE

(71) Applicant: HKC CORPORATION LIMITED, Baoan District (CN)

(72) Inventors: Jie YANG, Shenzhen (CN); Lei HU, Shenzhen (CN); Pei WU, Shenzhen (CN); Qiuyue GUO, Shenzhen (CN); Yan LIU, Shenzhen (CN); Jian TANG, Shenzhen (CN); Lidan YE, Shenzhen (CN)

(21) Appl. No.: 19/334,376

(22) Filed: Sep. 19, 2025

(30) Foreign Application Priority Data
Sep. 30, 2024 (CN) 202411391572.7

(51) Int. Cl. G02F 1/1677; G02F 1/167; G02F 1/16757

(52) U.S. Cl. CPC G02F 1/1677; G02F 1/167; G02F 1/16757

(57) ABSTRACT

An electrophoretic element, a display panel, and a display device are provided. The electrophoretic element is for the display panel and includes an electrophoretic cell, a first reflective structure, and a second reflective structure. The electrophoretic cell includes a cell body and an electrophoretic particle layer. The electrophoretic particle layer is disposed within the cell body, the cell body has a first surface and a second surface opposite the first surface, and the cell body is transparent. The first reflective structure is disposed on the first surface. The first reflective structure has a first reflective surface facing the electrophoretic cell. The second reflective structure is disposed on the second surface. The second reflective structure has a second reflective surface facing the electrophoretic cell. The electrophoretic particle layer is configured to move between the first surface and the second surface under an electric field.

### CROSS-REFERENCE TO RELATED APPLICATION(S)

This application claims priority under 35 U.S.C. § 119 (a) to Chinese Patent Application No. 202411391572.7, filed Sep. 30, 2024, the entire disclosure of which is incorporated herein by reference.

### TECHNICAL FIELD

The disclosure relates to the technical field of display panel, and in particular, to an electrophoretic element, a display panel, and a display device.

### BACKGROUND

The organic light-emitting diode (OLED) in a display panel is an emerging display technology. OLEDs have advantages such as self-emission, high contrast, and fast response, and are widely applied in various display devices. However, OLEDs also have some issues, such as high ambient light reflection and susceptibility to screen peeping.

### SUMMARY

In a first aspect, an electrophoretic element for a display panel is provided in the disclosure. The electrophoretic element includes an electrophoretic cell, a first reflective structure, and a second reflective structure. The electrophoretic cell includes a cell body and an electrophoretic particle layer. The electrophoretic particle layer is disposed within the cell body, the cell body has a first surface and a second surface opposite the first surface, and the cell body is transparent. The first reflective structure is disposed on the first surface. The first reflective structure has a first reflective surface facing the electrophoretic cell. The second reflective structure is disposed on the second surface. The second reflective structure has a second reflective surface facing the electrophoretic cell. The electrophoretic particle layer is configured to move between the first surface and the second surface, and to reflect light, under an electric field applied to the electrophoretic element.

In a second aspect, a display panel is provided in the disclosure. The display panel includes multiple pixels, a driving circuit layer, and the electrophoretic element provided in any one of the embodiments in the first aspect. The multiple pixels are disposed on the driving circuit layer and spaced apart from each other, the electrophoretic element is implemented as multiple electrophoretic elements, and for each of the multiple electrophoretic elements, the electrophoretic element is disposed between two adjacent pixels of the multiple pixels, and the multiple pixels and the multiple electrophoretic elements are electrically connected to the driving circuit layer.

In a third aspect, a display device is provided in the disclosure. The display device includes a housing and the display panel provided in any one of the embodiments in the second aspect. The display panel is received within the housing.

### BRIEF DESCRIPTION OF THE DRAWINGS

To describe technical solutions in embodiments of the disclosure or in the related art more clearly, the following briefly introduces the accompanying drawings required for describing the embodiments or the related art. Apparently, the accompanying drawings in the following description only illustrate some embodiments of the present disclosure. Those of ordinary skill in the art may also obtain other drawings based on these accompanying drawings without creative efforts.

FIG. 1 is a side view of an electrophoretic element in one state according to an embodiment.

FIG. 2 is a side view of an electrophoretic element in another state according to another embodiment.

FIG. 3 is a cross-sectional view of a display panel according to an embodiment.

FIG. 4 is a cross-sectional view of a display panel according to another embodiment.

FIG. 5 is a schematic view of a display device according to an embodiment.

Reference numerals are described as follows:
100—display panel, 10—electrophoretic element, 11—electrophoretic cell, 111—cell body, 112—electrophoretic particle layer, 113—electrophoretic particle, 114—first surface, 115—second surface, 12—first reflective structure, 121—first encapsulation layer, 122—first reflective layer, 123—first reflective surface, 13—second reflective structure, 131—second encapsulation layer, 132—second reflective layer, 133—second reflective surface, 14—first light-shielding layer, 15—second light-shielding layer, 16—mounting base, 20—pixel, 30—driving circuit layer, 40—anode layer, 50—cathode layer, 61—first inorganic encapsulation layer, 62—organic encapsulation layer, 63—second inorganic encapsulation layer, 70—substrate base, 80—light-emitting layer, 200—housing.

### DETAILED DESCRIPTION

Technical solutions in embodiments of the disclosure are clearly and completely described in the following with reference to the accompanying drawings in the embodiments of the disclosure. Apparently, the described embodiments are merely part of rather than all of the embodiments of the disclosure. All other embodiments obtained by those of ordinary skill in the art based on the embodiments of the disclosure without creative efforts shall fall within the scope of the disclosure.

It is noted that when a component is referred to as being “fixed to” another component, the component may be fixed directly to the other component or fixed indirectly thereto through an intermediate component. When a component is referred to as being “connected to” another component, the component may be connected directly to the other component or connected indirectly thereto through an intermediate component.

Unless otherwise defined, all technical and scientific terms used herein have the same meaning as commonly understood by those skilled in the art of the disclosure. The terms used herein in the disclosure are for merely describing embodiments rather than intending to limit the disclosure. The term “and/or” used in the disclosure includes any and all combinations of one or more of the associated listed items.

Some embodiments of the disclosure will be described in detail below with reference to the accompanying drawings. The following embodiments as well as features therein can be combined with each other without inconsistency.

In order to solve problems such as high ambient light reflection and susceptibility to peeping in display panels, in the prior art, a polarizer or a black matrix (BM) is usually added to an OLED display screen to reduce ambient light reflection and prevent peeping. A polarizer can reduce the ambient light reflection and improve the display effect, but it also diminishes screen brightness. The black matrix can prevent color mixing and improve display quality, but it also increases the thickness and weight of the display screen. In addition, these methods still exhibit limitations in adjusting the anti-peeping viewing angle.

The disclosure aims to provide an electrophoretic element, a display panel, and a display device, so as to solve a problem of susceptibility to peeping in the display panel.

To achieve an objective of the disclosure, the following technical solutions are provided.

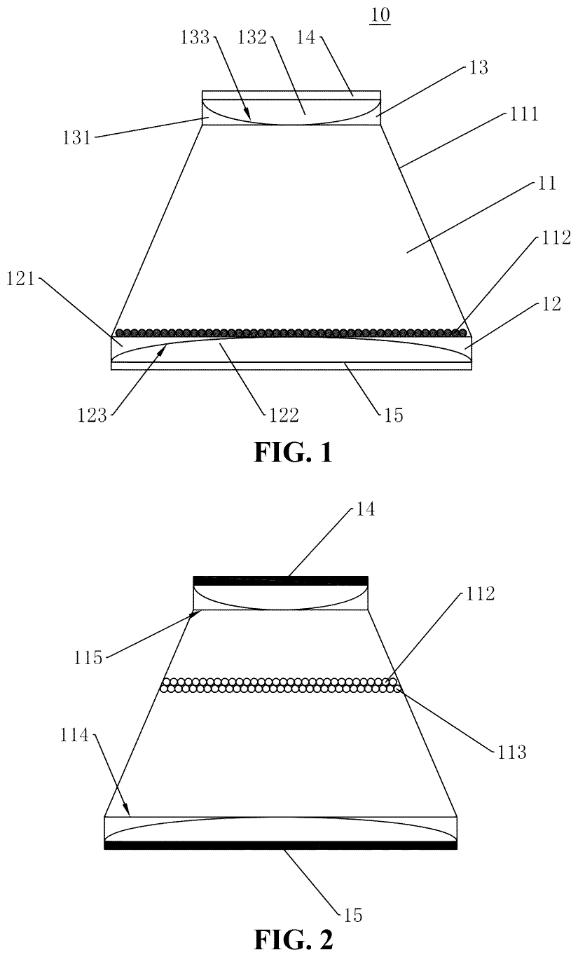

In FIG. 1, an electrophoretic element 10 is in a normal mode, i.e., a non-activated state. In FIG. 2, the electrophoretic element 10 is in an activated state.

Referring to FIG. 1 and FIG. 2, an electrophoretic element 10 for a display panel 100 is provided in the disclosure. The electrophoretic element 10 includes an electrophoretic cell 11, a first reflective structure 12, and a second reflective structure 13. The electrophoretic cell 11 includes a cell body 111 and an electrophoretic particle layer 112. The electrophoretic particle layer 112 is disposed within the cell body 111, the cell body 111 has a first surface 114 and a second surface 115 opposite the first surface 114, and the cell body 111 is transparent. The first reflective structure 12 is disposed on the first surface 114. The first reflective structure 12 has a first reflective surface 123 facing the electrophoretic cell 11. The second reflective structure 13 is disposed on the second surface 115. The second reflective structure 13 has a second reflective surface 133 facing the electrophoretic cell 11. The electrophoretic particle layer 112 is configured to move between the first surface 114 and the second surface 115 under an electric field. The electrophoretic particle layer 112 is configured to reflect light when the electrophoretic element 10 is in an activated state. In other words, the electrophoretic particle layer is configured to move between the first surface and the second surface, and to reflect light, under an electric field applied to the electrophoretic element.

The cell body 111 is made of a transparent conductive material, which may specifically be indium tin oxide (ITO), a conductive polymer (such as poly(3,4-ethylenedioxythiophene), PEDOT), a metal thin film, or the like. The metal thin film may be, but is not limited to, a silver thin film, a copper thin film, an aluminum thin film, or the like.

The electrophoretic particle layer 112 includes multiple electrophoretic particles 113. Each electrophoretic particle 113 is a charged particle or microparticle that can move under an electric field during electrophoresis. The electrophoretic particle 113 may be classified based on its chemical composition into organic nanoparticles and inorganic nanoparticles; may be classified based on its optical properties into light-absorbing particles, light-scattering particles, fluorescent particles, electrochromic particles, photochromic particles, and photonic crystals; and may be classified based on its structure into monophasic particles and composite particles (e.g., coated modified particles, graft modified particles, doped particles, adsorbed modified particles, etc.).

Optionally, both the first surface 114 and the second surface 115 are planar surfaces. In the case where the first surface 114 and/or the second surface 115 are curved surfaces, an additional encapsulation structure is required to ensure that end faces of the electrophoretic cell 11 in a stacking direction is flat, facilitating the assembly of the electrophoretic element 10.

Optionally, a supporting medium is filled in the cell body 111 to facilitate the movement of the electrophoretic particles 113. Depending on the supporting medium, the electrophoretic cell 11 can be categorized into filter paper electrophoresis, cellulose acetate membrane electrophoresis, thin-layer electrophoresis, gel electrophoresis, etc. In addition, depending on the structural form of the supporting medium, the electrophoretic cell 11 can also be categorized into horizontal slab electrophoresis, vertical slab electrophoresis, vertical disc electrophoresis, capillary electrophoresis, bridge electrophoresis, and continuous flow electrophoresis.

The electrophoretic element 10 of the disclosure is provided with the first reflective structure 12, the electrophoretic cell 11, and the second reflective structure 13, which are sequentially stacked. When the electrophoretic element 10 is not energized, the electrophoretic particle layer 112 in the electrophoretic cell 11 appears black and is positioned at the bottom of the electrophoretic cell 11. At this time, the electrophoretic particle layer 112 serves as a light-shielding material, and the electrophoretic cell 11 functions to block light, thereby preventing color mixing. When the electrophoretic element 10 is energized, i.e., in a privacy mode, the electrophoretic particle layer 112 in the electrophoretic cell 11 cooperates with the first reflective surface 123 and the second reflective surface 133 to reflect light, such that color mixing occurs at certain viewing angles, namely, at peeping angles. As a result, an image observed from an anti-peeping angle differs from the original image, thus providing the electrophoretic element 10 with a privacy protection effect. The position of the electrophoretic particle layer 112 within the electrophoretic cell 11 varies with the magnitude of the electric field, thereby enabling adjustment of the anti-peeping angle of a privacy protection device.

Additionally, since it is unnecessary to additionally provide a light-shielding layer near a light-emitting side of the display panel 100 to prevent color mixing, a viewing angle of the display panel 100 is improved. The electrophoretic particle 113 in the electrophoretic cell 11 has bistable characteristic and can maintain its energized state for a certain period after power-off upon reaching a desired privacy position, thereby reducing power consumption for privacy protection to a certain extent. Since both ambient light and light emitted from pixels 20 are utilized, the light efficiency utilization is improved, and an aperture ratio of the pixel (i.e., a ratio of a light-transmitting area of the pixel 20 to the total area of the pixel 20) is increased.

In one embodiment, the first reflective surface 123 is any one of: a curved surface, a combination of planar surfaces, a combination of a planar surface and a curved surface, or a combination of curved surfaces; and the second reflective surface 123 is any one of: a curved surface, a combination of planar surfaces, a combination of a planar surface and a curved surface, or a combination of curved surfaces.

Optionally, the first reflective surface 123 and/or the second reflective surface 133 include a combination of planar surfaces to form a reflective surface in a sawtooth shape. The sawtooth shape may be formed by multiple triangles and/or rectangles. The curved surface may be either a major arc or a minor arc, which is not limited herein.

Optionally, the first reflective surface 123 primarily cooperates with the electrophoretic particle layer 112 to reflect ambient light, and the second reflective surface 133 primarily cooperates with the electrophoretic particle layer 112 to reflect pixel light.

Defining the shapes of the first reflective surface 123 and the second reflective surface 133 helps to enhance the reflective interaction between the first reflective surface 123 and the electrophoretic particle layer 112, as well as between the second reflective surface 133 and the electrophoretic particle layer 112, thereby improving the utilization of both ambient light and pixel light.

Referring to FIG. 1 and FIG. 2, in one embodiment, the first reflective structure 12 includes a first encapsulation layer 121 and a first reflective layer 122. The first reflective layer 122 has a first reflective surface 123 and is received within the first encapsulation layer 121. The first encapsulation layer 121 is transparent.

The material of the first encapsulation layer 121 may include, but is not limited to, UV-curable adhesive, epoxy thermosetting adhesive, polyimide (PI), polyethylene terephthalate (PET), or the like.

Similarly, the second reflective structure 13 includes a second encapsulation layer 131 and a second reflective layer 132. The second reflective layer 132 has a second reflective surface 133 and is received within the second encapsulation layer 131. The second encapsulation layer 131 is transparent.

Optionally, the first reflective layer 122 and the second reflective layer 132 may be composed of materials capable of efficiently reflecting light. Such materials may include metal thin films, high-reflectivity polymers, or multilayer film structures. The metal thin film may be an aluminum thin film, and the multilayer film structure may be a structure such as a distributed Bragg reflector (DBR), which is formed by stacking multiple layers using materials having different refractive indices, so as to efficiently reflect light of specific wavelengths.

The provision of the first encapsulation layer 121 can enhance the connection strength between the first reflective structure 12 and the electrophoretic cell 11, thereby avoiding connection instability between the first reflective structure 12 and the electrophoretic cell 11 caused by the irregular shape of the first reflective surface 123.

In one embodiment, a cross section of the electrophoretic cell 11 is in a shape of an isosceles trapezoid. The first surface 114 serves as a lower surface of the isosceles trapezoid, and the second surface 115 serves as an upper surface of the isosceles trapezoid.

Optionally, a smaller base angle of the isosceles trapezoid results in a greater size difference between the first reflective surface 123 and the second reflective surface 133.

The cross section of the electrophoretic cell 11 is in a shape of an isosceles trapezoid, so that the electrophoretic element 10 can have a consistent reflection for both the pixel light and ambient light from either side. The isosceles trapezoid design helps to better control the transmission and reflection of light within the pixel 20, thereby reducing scattering and light leakage, improving display contrast and color accuracy, and also enhancing the display performance of the display panel 100 at different viewing angles by reducing color shift and brightness variation.

The isosceles trapezoidal electrophoretic cell 11 also cooperates with the remaining structures of the electrophoretic element 10 to define a boundary and shape of the pixel 20. The isosceles trapezoidal electrophoretic cell 11 also constitutes a main component of the electrophoretic element 10, such that the cross-sectional shape of the electrophoretic element 10 approximates an isosceles trapezoid, facilitating the manufacture of the electrophoretic element 10. The manufacturing process for the electrophoretic element 10 and the display panel 100 generally includes coating, inkjet printing, etching, etc. In the case where an organic material film layer is fabricated through inkjet printing, the trapezoidal design helps to reduce the climbing of a solution along side surfaces of the electrophoretic element 10, which can improve the uniformity of film formation within the pixel 20, thereby improving the display performance. By precisely controlling the shape and size of the electrophoretic cell 11 and the electrophoretic element 10, short circuits between an anode layer 40 and a cathode layer 50, as well as open circuits of the cathode layer 50, can be avoided, thereby improving the yield and reliability of the display panel 100.

Referring to FIG. 1, in one embodiment, the electrophoretic element 10 further includes a first light-shielding layer 14 disposed on a side of the second reflective structure 13 away from the electrophoretic cell 11.

The first light-shielding layer 14 may either consistently/permanently block light, or may only blocking light when the electrophoretic element 10 is under an electric field, which is not limited herein.

The first light-shielding layer 14 primarily functions to block light when the electrophoretic element 10 is under an electric field (i.e., when the electrophoretic particle layer 112 appears black). The first light-shielding layer 14 is used to enhance the display effect of the display panel 100. The first light-shielding layer 14 can effectively prevent ambient light from reflecting on a surface of the display panel 100, thereby reducing glare. The first light-shielding layer 14 can also improve color accuracy and ensure that the display panel 100 operates under standard light sources without interference from ambient light, thereby improving the color accuracy and fidelity.

Referring to FIG. 1 and FIG. 2, in one embodiment, the first light-shielding layer 14 is an electrochromic darkening layer.

Optionally, the material of the first light-shielding layer 14 may also be any one of magnesium oxide, aluminum oxide, silver oxide, or black matrix material.

Optionally, the black matrix material may be, but is not limited to, chromium (Cr) and its oxides (CrOx), black resin, etc.

Optionally, the electrochromic darkening layer is made of an electrochromic darkening material, which may be transition metal oxides and their derivatives, such as tungsten trioxide (WO₃), nickel oxide (NiO), etc., which is not limited herein. When the electrophoretic element 10 is not energized and the first light-shielding layer 14 is made of the electrochromic darkening material, the first light-shielding layer 14 is transparent, and the electrophoretic particles 113 in the electrophoretic cell 11 are black, such that the electrophoretic cell 11 functions to block light, thereby preventing color mixing. When the electrophoretic element 10 is energized and the first light-shielding layer 14 is made of the electrochromic darkening material, the first light-shielding layer 14 changes from transparent to black, functioning to block light.

In the case where the first light-shielding layer 14 is made of magnesium oxide, aluminum oxide, silver oxide, black matrix material, or the like, the first light-shielding layer 14 consistently/permanently blocks light in the electrophoretic element 10. In the case where the first light-shielding layer 14 is an electrochromic darkening layer, the first light-shielding layer 14 may be light-colored or colorless in a non-energized state, and becomes black under an electric field to function to block light.

Referring to FIG. 1, in one embodiment, the electrophoretic element 10 further includes a second light-shielding layer 15 disposed on a side of the first reflective structure 12 away from the electrophoretic cell 11.

With reference to the first light-shielding layer 14, the material of the second light-shielding layer 15 may be, but is not limited to, magnesium oxide, aluminum oxide, silver oxide, black matrix material, or electrochromic material.

Optionally, the second light-shielding layer 15 is disposed corresponding to the first surface 114 of the electrophoretic cell 11.

The second light-shielding layer 15 may be configured to block part of light reflected by the first reflective structure 12 and part of light reflected by the electrophoretic particle layer 112. The second light-shielding layer 15 can further improve the display effect and color accuracy of the display panel 100.

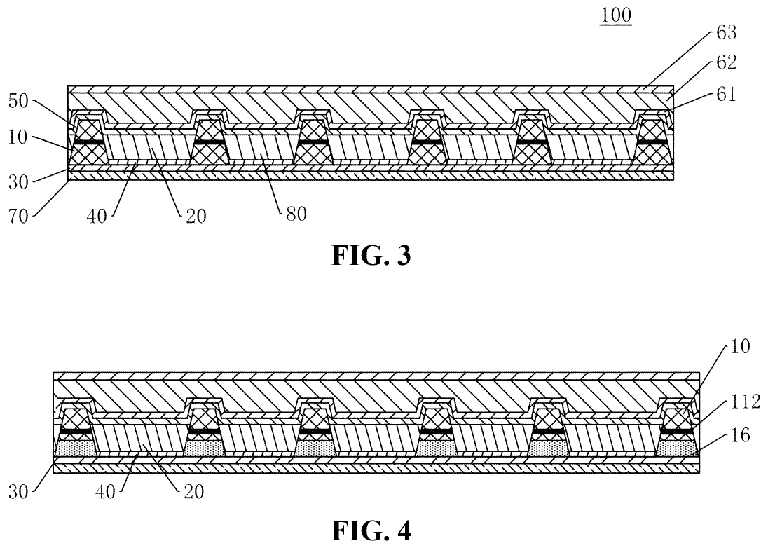

Referring to FIG. 3, in one embodiment, the electrophoretic element 10 further includes a mounting base 16 disposed on a side of the second light-shielding layer 15 away from the first reflective structure 12. The mounting base 16 is of a light-shielding structure.

The material of the mounting base 16 may be metal, and may specifically be aluminum or silver, without limitation. Optionally, the mounting base 16 further includes a protective layer. The protective layer may be made of aluminum oxide (Al₂O₃), silicon dioxide (SiO₂), silicon nitride (SiN), or other materials, and is configured to improve the stability of the mounting base 16.

The mounting base 16 functions as a pixel definition layer, separating adjacent pixels 20 and defining boundaries and shapes of the pixels 20. The mounting base 16 is used to elevate the second light-shielding layer 15 such that both the second light-shielding layer 15 and the first reflective structure 12 extend beyond a surface of the anode layer 40 of the display panel 100 away from a driving circuit layer 30, thereby preventing color mixing.

Specifically, in a first embodiment, the electrophoretic element 10 includes the first light-shielding layer 14, the first reflective structure 12, the second reflective structure 13, and the electrophoretic cell 11, where the first light-shielding layer 14 is an electrochromic darkening layer. When the electrophoretic element 10 is in the normal mode (i.e., when the electrophoretic element 10 is not energized), the first light-shielding layer 14 is transparent, and the electrophoretic particle layer 112 functions to block light to prevent color mixing. When the electrophoretic element 10 is in the energized state (i.e., when the electrophoretic element 10 is in the privacy mode), the first light-shielding layer 14 becomes black to block light.

In a second embodiment, the electrophoretic element 10 includes the first light-shielding layer 14, the first reflective structure 12, the second reflective structure 13, and the electrophoretic cell 11, where the first light-shielding layer 14 is made of a non-color-changing material. In the normal mode, the first light-shielding layer 14 is opaque, and the first light-shielding layer 14 together with the electrophoretic particle layer 112 function to block light to prevent color mixing. In the privacy mode, the first light-shielding layer 14 still functions to block light.

In a third embodiment, the electrophoretic element 10 includes the first light-shielding layer 14, the first reflective structure 12, the second reflective structure 13, the electrophoretic cell 11, and the second light-shielding layer 15, where both the first light-shielding layer 14 and the second light-shielding layer 15 are electrochromic darkening layers. In the normal mode, both the first light-shielding layer 14 and the second light-shielding layer 15 are transparent, and the black electrophoretic particle layer 112 functions to block light to prevent color mixing and also absorbs the pixel light and ambient light reflected by the first reflective layer 122 and the second reflective layer 132, thereby not forming a privacy effect. In the privacy mode of the electrophoretic element 10, the first light-shielding layer 14 and the second light-shielding layer 15 change from transparent to black to perform the light-blocking function, and the electrophoretic particle layer 112 moves a corresponding distance in a direction from the first surface 114 toward the second surface 115 according to the strength of the electric field in the electrophoretic element 10. At this time, the electrophoretic particle layer 112 becomes reflective and cooperates with the first reflective layer 122 and the second reflective layer 132 to reflect the pixel light and ambient light out of the display device to realize the privacy effect.

Referring to FIG. 3 and FIG. 4, the disclosure provides a display panel 100. The display panel 100 includes multiple pixels 20, the driving circuit layer 30, and the electrophoretic element 10 provided in any one of the foregoing embodiments. The multiple pixels 20 are disposed on the driving circuit layer 30 and spaced apart from each other. The electrophoretic element 10 is implemented as multiple electrophoretic elements 10, and for each of the multiple electrophoretic elements 10, the electrophoretic element 10 is disposed between two adjacent pixels 20 of the multiple pixels 20. The multiple pixels 20 and the multiple electrophoretic elements 10 are electrically connected to the driving circuit layer 30.

Each pixel 20 includes a light-emitting layer 80. The light-emitting layer 80 includes multiple sub-pixels, which may be, but is not limited to, red sub-pixels, green sub-pixels, blue sub-pixels, or the like. By adjusting the brightness and color of the sub-pixels, a rich and colorful image can be displayed.

The material of the red sub-pixel may be a phosphorescent material, which may specifically be, but is not limited to, rubrene, 2,5,8,11-tetra-tert-butylperylene (PTPP), 4-(dicyanomethylene)-2-tert-butyl-6-(1,1,7,7-tetramethyljulolidyl-9-enyl)-4H-pyran (DCJTB), tetrazole-based red-light emitter, or the like. The high luminous efficiency of the phosphorescent material provides good performance for the red sub-pixel, ensuring the vividness and saturation of red display. The material of the green sub-pixel may be a phosphorescent material, which may specifically be, but is not limited to, tris(8-hydroxyquinoline)aluminum (Alq₃), 1,3,5-tris(2-(4-(diphenylamino)phenyl) ethenyl)benzene (TDETE), coumarin, naphthalene-based green-light emitter (NpGl), or the like. The high-efficiency luminescent characteristics of the phosphorescent material ensure the green sub-pixel to achieve a stable green display effect in the display panel 100. The material of the blue sub-pixel may be, but is not limited to, a fluorescent material, a phosphorescent material, or the like.

Each pixel 20 further includes an anode layer 40. The anode layer 40 is disposed on the driving circuit layer 30, and the light-emitting layer 80 is disposed on a corresponding anode layer 40. The anode layer 40 may be, but is not limited to, ITO, aluminum-doped zinc oxide (AZO), gallium-doped zinc oxide (GZO), silver (Ag), a polymer conductive film, or the like.

Each pixel 20 further includes a cathode layer 50. The cathode layer 50 is disposed on a side of the electrophoretic element 10 away from the driving circuit layer 30, as well as a side of the light-emitting layer 80 away from the driving circuit layer 30. The cathode layer 50 is shared among the multiple pixels 20. The cathode layer 50 may be, but is not limited to, a single-layer metal cathode, an alloy cathode, a laminated cathode, or the like. The metal cathode may be made of Ag, Al, lithium (Li), magnesium (Mg), calcium (Ca), indium (In), or the like. The alloy cathode may be composed of, for example, magnesium-silver alloy (Mg:Ag, 10:1), lithium-aluminum alloy (Li:Al, 0.6% Li), or the like. The laminated cathode includes a metal cathode and a barrier layer, where the barrier layer is disposed between the metal cathode and the pixel 20. The material of the metal cathode may be, but is not limited to, lithium fluoride (LiF), cesium fluoride (CsF), rubidium fluoride (RbF), or the like.

In addition to realizing the privacy function of the display panel 100, the electrophoretic element 10 also replaces the pixel definition layer. The electrophoretic element 10 exposes the anode layer 40 or other electrodes, separates adjacent pixels 20, and defines the boundary and shape of the pixel 20.

Optionally, the display panel 100 further includes an encapsulation portion. The encapsulation portion includes a first inorganic encapsulation layer 61, an organic encapsulation layer 62, and a second inorganic encapsulation layer 63, which are sequentially stacked. The first inorganic encapsulation layer 61 is closer to the cathode layer 50 than the organic encapsulation layer 62.

The material of the organic encapsulation layer 62 may be, but is not limited to, epoxy resin, PI, polycarbonate, polyphenylene sulfide, or the like.

The materials of the first inorganic encapsulation layer 61 and the second inorganic encapsulation layer 63 may include oxides, nitrides, metals, compounds thereof, etc., and may specifically include aluminum oxide, silicon nitride, which is not limited herein.

The organic encapsulation layer 62 has good flexibility and buffering performance, which can absorb external impact and stress to a certain extent, thereby protecting display elements inside the display panel 100 from damage. The organic encapsulation layer 62 also has a certain capability of blocking harmful external substances such as moisture and oxygen. Furthermore, the organic encapsulation layer 62 has high light transmittance, which helps maintain the clarity and brightness of the display panel 100. The organic encapsulation layer 62 can be formed by various methods, such as inkjet printing, spin coating, and blade coating, so as to precisely control the coating thickness and uniformity of the organic material, thereby meeting the requirements of the encapsulation structure.

The first inorganic encapsulation layer 61 and the second inorganic encapsulation layer 63 have good sealing performance, and are capable of effectively blocking external harmful external substances such as moisture and oxygen from corroding the display element, thereby improving the reliability and service life of the display panel 100. The first inorganic encapsulation layer 61 and the second inorganic encapsulation layer 63 also have high hardness and wear resistance, and are capable of protecting the display panel 100 from scratches and abrasion. The first inorganic encapsulation layer 61 and the second inorganic encapsulation layer 63 are also required to have good optical transmittance to ensure that the display effect of the display panel 100 is not adversely affected. The first inorganic encapsulation layer 61 and the second inorganic encapsulation layer 63 may be formed by vapor deposition methods (such as chemical vapor deposition (CVD) and physical vapor deposition (PVD)), atomic layer deposition (ALD), or the like, to form uniform and dense inorganic thin film layers, thereby enhancing the performance of the encapsulation structure.

Optionally, the display panel 100 further includes a substrate base 70, and the substrate base 70 is disposed on a side of the driving circuit layer 30 away from the electrophoretic element 10. The substrate base 70 serves as a foundational support structure for the display panel 100. Common materials of the substrate base 70 include glass, plastic (such as polyimide), metal, and certain special ceramics or composite materials.

In the display panel 100 of the disclosure, the sequentially stacked structure of the first inorganic encapsulation layer 61, the organic encapsulation layer 62, and the second inorganic encapsulation layer 63 not only utilizes the flexibility and buffering properties of the organic encapsulation layer 62, but also takes advantage of the high sealing property and wear resistance of the inorganic encapsulation layers, thereby achieving comprehensive protection for the display element.

The display panel 100 of the disclosure realizes the privacy protection function by utilizing both ambient light and light emitted by the pixels 20, thereby enhancing the privacy protection effect of the display panel 100. Furthermore, the position of the electrophoretic particles 113 in the electrophoretic cell 11 is changed in response to the magnitude of current during energization of the electrophoretic particle layer 112 in the electrophoretic cell 11, thereby enabling an adjustable privacy viewing angle and increasing the pixel aperture of the display panel 100. In addition, since it is not necessary to additionally provide a light-shielding layer near the light-emitting side of the display panel 100 to prevent color mixing, the viewing angle of the display panel 100 is improved. Due to the bistable characteristic of the electrophoretic particles 113, their energized state can be maintained for a certain period after power-off, thereby reducing, to a certain extent, the power consumption for privacy protection function of the display panel 100.

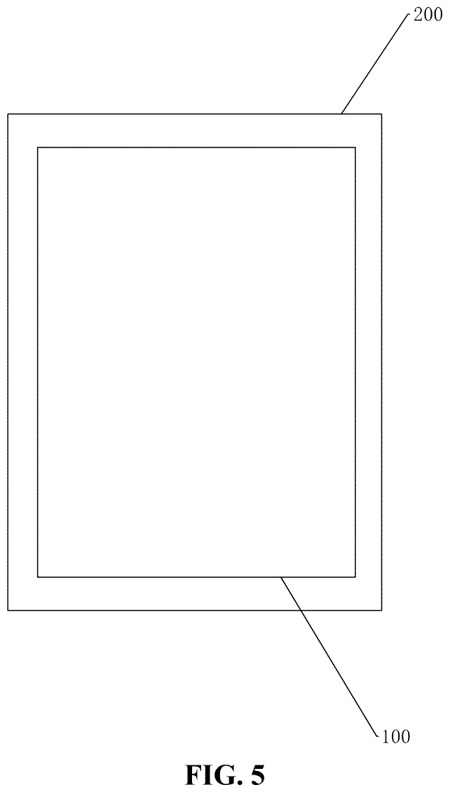

Referring to FIG. 5, the disclosure provides a display device. The display device includes a housing 200 and the display panel 100 provided in any one of the foregoing embodiments. The display panel 100 is received within the housing 200.

The display device may be a television, electronic device, monitor, or the like. The electronic device may be, but is not limited to, a mobile phone, computer, smart wearable device, or the like.

Optionally, the display device further includes a driving circuit, control board, interface, power supply, other components, or the like.

The driving circuit is adapted to provide proper voltages and signals to the display panel 100 to control the brightness and color of the light-emitting layer. The driving circuit may include a source driver and a gate driver, which are respectively configured to provide signals to the rows and columns of the display panel 100.

The control board is adapted to receive signals (such as video signals) from external devices and convert the signals into signals understandable by the driving circuit. The control board may also be used for image processing to optimize the display effect of images.

The interface may be, but is not limited to, High-Definition Multimedia Interface (HDMI), a DisplayPort interface, a Universal Serial Bus Type-C (USB-C) interface, or the like, so as to allow the display device to be connected to external devices such as a computer, a game console, and a media player.

The housing 200 is adapted to provide physical protection and support for the display device, while protecting internal components from dust, moisture, and other external factors.

The power supply is adapted to provide electrical power required by the display device, and may be an internal power adapter or a battery.

The other components may include a touch screen, speaker, camera, sensor, or the like.

The display device of the disclosure has high light efficiency utilization, thereby increasing the pixel aperture of the display device.

The display panel of the disclosure can realize the privacy protection function by utilizing both ambient light and light emitted by the pixels 20, thereby enhancing the privacy protection effect of the display device. Furthermore, the position of the electrophoretic particles 113 in the electrophoretic cell 11 is changed in response to the magnitude of current during energization of the electrophoretic particle layer 112 in the electrophoretic cell 11, thereby enabling an adjustable privacy viewing angle. In addition, since it is not necessary to additionally provide a light-shielding layer near the light-emitting side of the display panel 100 to prevent color mixing, the viewing angle of the display panel 100 is improved. Due to the bistable characteristic of the electrophoretic particles 113, their energized state can be maintained for a certain period after power-off, thereby reducing, to a certain extent, the power consumption for privacy protection function of the display panel 100.

It is understood that terms such as “center”, “upper”, “lower”, “left”, “right”, “vertical”, “horizontal”, “inner”, “outer” referred to in the embodiments of the disclosure which indicate directional relationship or positional relationship are directional relationship or positional relationship based on accompanying drawings and are only for the convenience of the disclosure and simplicity, rather than explicitly or implicitly indicate that devices or components referred to herein must have a certain direction or be configured or operated in a certain direction and therefore cannot be understood as limitation on the disclosure.

The above embodiments are only preferred embodiments of the disclosure and should not be construed as limiting the scope of the disclosure. Those skilled in the art may understand all or part of the processes to implement the above embodiments of the disclosure and make equivalent variations according to the claims of this disclosure, which still fall within the scope of the disclosure.

What is claimed is:

1. An electrophoretic element for a display panel, comprising:
an electrophoretic cell comprising a cell body and an electrophoretic particle layer, wherein the electrophoretic particle layer is disposed within the cell body, the cell body has a first surface and a second surface opposite the first surface, and the cell body is transparent;
a first reflective structure disposed on the first surface, wherein the first reflective structure has a first reflective surface facing the electrophoretic cell; and
a second reflective structure disposed on the second surface, wherein the second reflective structure has a second reflective surface facing the electrophoretic cell;
the electrophoretic particle layer is configured to move between the first surface and the second surface, and to reflect light, under an electric field applied to the electrophoretic element.

2. The electrophoretic element according to claim 1, wherein the first reflective surface is any one of: a curved surface, a combination of planar surfaces, a combination of a planar surface and a curved surface, or a combination of curved surfaces; and the second reflective surface is any one of: a curved surface, a combination of planar surfaces, a combination of a planar surface and a curved surface, or a combination of curved surfaces.

3. The electrophoretic element according to claim 1, wherein the first reflective structure comprises a first encapsulation layer and a first reflective layer, the first reflective layer has the first reflective surface and is received within the first encapsulation layer, and the first encapsulation layer is transparent.

4. The electrophoretic element according to claim 1, wherein a cross section of the electrophoretic cell is in a shape of an isosceles trapezoid, the first surface serves as a lower surface of the isosceles trapezoid, and the second surface serves as an upper surface of the isosceles trapezoid.

5. The electrophoretic element according to claim 1, further comprising a first light-shielding layer disposed on a side of the second reflective structure away from the electrophoretic cell.

6. The electrophoretic element according to claim 5, wherein the first light-shielding layer is an electrochromic layer.

7. The electrophoretic element according to claim 5, further comprising a second light-shielding layer disposed on a side of the first reflective structure away from the electrophoretic cell.

8. The electrophoretic element according to claim 7, further comprising a mounting base disposed on a side of the second light-shielding layer away from the first reflective structure, wherein the mounting base is of a light-shielding structure.

9. A display panel, comprising a plurality of pixels, a driving circuit layer, and an electrophoretic element, the electrophoretic element comprising an electrophoretic cell, a first reflective structure, and a second reflective structure, wherein
an electrophoretic cell comprising a cell body and an electrophoretic particle layer, wherein the electrophoretic particle layer is disposed within the cell body, the cell body has a first surface and a second surface opposite the first surface, and the cell body is transparent;
a first reflective structure disposed on the first surface, wherein the first reflective structure has a first reflective surface facing the electrophoretic cell; and
a second reflective structure disposed on the second surface, wherein the second reflective structure has a second reflective surface facing the electrophoretic cell;
the electrophoretic particle layer is configured to move between the first surface and the second surface, and to reflect light, under an electric field applied to the electrophoretic element;
the plurality of pixels are disposed on the driving circuit layer and spaced apart from each other, the electrophoretic element is implemented as a plurality of electrophoretic elements, and for each of the plurality of electrophoretic elements, the electrophoretic element is disposed between two adjacent pixels of the plurality of pixels, and the plurality of pixels and the plurality of electrophoretic elements are electrically connected to the driving circuit layer.

10. The display panel according to claim 9, wherein the first reflective surface is any one of: a curved surface, a combination of planar surfaces, a combination of a planar surface and a curved surface, or a combination of curved surfaces; and the second reflective surface is any one of: a curved surface, a combination of planar surfaces, a combination of a planar surface and a curved surface, or a combination of curved surfaces.

11. The display panel according to claim 9, wherein the first reflective structure comprises a first encapsulation layer and a first reflective layer, the first reflective layer has the first reflective surface and is received within the first encapsulation layer, and the first encapsulation layer is transparent.

12. The display panel according to claim 9, wherein a cross section of the electrophoretic cell is in a shape of an isosceles trapezoid, the first surface serves as a lower surface of the isosceles trapezoid, and the second surface serves as an upper surface of the isosceles trapezoid.

13. The display panel according to claim 9, further comprising a first light-shielding layer disposed on a side of the second reflective structure away from the electrophoretic cell.

14. The display panel according to claim 13, wherein the first light-shielding layer is an electrochromic layer.

15. The display panel according to claim 13, further comprising a second light-shielding layer disposed on a side of the first reflective structure away from the electrophoretic cell.

16. The display panel according to claim 15, further comprising a mounting base disposed on a side of the second light-shielding layer away from the first reflective structure, wherein the mounting base is of a light-shielding structure.

17. A display device, comprising a housing and a display panel received within the housing, the display panel comprising a plurality of pixels, a driving circuit layer, and an electrophoretic element, the electrophoretic element comprising an electrophoretic cell, a first reflective structure, and a second reflective structure, wherein
an electrophoretic cell comprising a cell body and an electrophoretic particle layer, wherein the electrophoretic particle layer is disposed within the cell body, the cell body has a first surface and a second surface opposite the first surface, and the cell body is transparent;
a first reflective structure disposed on the first surface, wherein the first reflective structure has a first reflective surface facing the electrophoretic cell; and
a second reflective structure disposed on the second surface, wherein the second reflective structure has a second reflective surface facing the electrophoretic cell;
the electrophoretic particle layer is configured to move between the first surface and the second surface, and to reflect light, under an electric field applied to the electrophoretic element;
the plurality of pixels are disposed on the driving circuit layer and spaced apart from each other, the electrophoretic element is implemented as a plurality of electrophoretic elements, and for each of the plurality of electrophoretic elements, the electrophoretic element is disposed between two adjacent pixels of the plurality of pixels, and the plurality of pixels and the plurality of electrophoretic elements are electrically connected to the driving circuit layer.

18. The display device according to claim 17, wherein the first reflective surface is any one of: a curved surface, a combination of planar surfaces, a combination of a planar surface and a curved surface, or a combination of curved surfaces; and the second reflective surface is any one of: a curved surface, a combination of planar surfaces, a combination of a planar surface and a curved surface, or a combination of curved surfaces.

19. The display device according to claim 17, wherein the first reflective structure comprises a first encapsulation layer and a first reflective layer, the first reflective layer has the first reflective surface and is received within the first encapsulation layer, and the first encapsulation layer is transparent.

20. The display device according to claim 17, wherein a cross section of the electrophoretic cell is in a shape of an isosceles trapezoid, the first surface serves as a lower surface of the isosceles trapezoid, and the second surface serves as an upper surface of the isosceles trapezoid.
